(19) United States
(12) Patent Application Publication
(10) Pub. No.: US 2005/0144634 A1
(43) Pub. Date: Jun. 30, 2005

(54) Method for providing pay-TV service based on session key

(76) Inventors: Han-Seung Koo, Daejon (KR); O-Hyung Kwon, Daejon (KR); Soo-In Lee, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/971,167

(22) Filed: Oct. 22, 2004

(30) Foreign Application Priority Data
Dec. 26, 2003 (KR) 2003-97795

(51) Int. Cl. H04N 7/167; H04K 1/00; H04L 9/00

(52) U.S. Cl. 725/31; 380/255; 380/278; 380/282; 380/210

(57) ABSTRACT

Disclosed is a method for providing a pay-TV service based on a session key. The method includes the steps of: selecting a desired pay event using a program guide displayed on a system of the subscriber and achieving a subscriber private key; filling out a service application based on service information, signing the service application based on a digital signature scheme and encrypting the digital signed service application; transmitting the encrypted service application to a broadcasting station and waiting a response of the broadcasting station; receiving a session key and a subscription authority message from the broadcasting station, decrypting the session key and the subscription authority message and verifying the digital signature; decrypting a channel key, achieving a control word, descrambling event audio/video streams and watching the event; and if the event is terminated or the session key is not effective, stopping watching the event and deleting the session key.

### FIELD OF THE INVENTION

The present invention relates to a method for providing a pay-television (TV) service based on a session key, which can provides various pay-services per event to authenticated subscribers in a digital television (TV) broadcasting system.

### DESCRIPTION OF RELATED ART

Generally, a pay-TV service includes a pay-service per channel and a pay-service per event in a digital TV broadcasting system.

FIG. 1 is a block diagram showing a conventional pay-TV service.

As shown, a pay-TV service 101 includes the pay-service per channel 102 and the pay-service per event 103.

The pay-service per channel 102 includes a package service and a premium channel service. The PPV 103 service includes a pay-per-event (PPE) service, a pay-per-duration (PPD) service, a pay-per-series (PPS) service, a near-video-on-demand (nVOD) service and a video-on-demand (VOD) service.

For using the above-mentioned services, a user has to subscribe to a digital TV broadcasting station (hereinafter refer as a broadcasting station). The broadcasting station transmits a decryption key and pay-TV subscription authority information based on an entitlement control message (ECM) and an entitlement management message (EMM) to the user.

In a prior art, the ECM and the EMM are encrypted based on a symmetric encryption-based key, which all subscribers have. Wherein effective subscribers can decrypt only the EMM including the pay-TV subscription authority information and read the pay-TV subscription authority information. A conditional access module (CAM) allows providing pay-TV subscription authority to the subscribers based on the pay-TV subscription authority information. The pay-TV subscription authority information includes an event identifier, a theme discriminator and a term of validity, etc.

However, in the prior art, because the pay-TV service can provide only to the effective subscribers, various and intelligent services are hard to be provided.

### SUMMARY OF THE INVENTION

It is, therefore, an object of the present invention to provide a method for providing a pay-TV service, wherein the method provides safely the pay-TV service to an authorized user and can provide a pay-service per event of each programs provided through a pay channel.

In accordance with an aspect of the present invention, there is provided a method for providing a pay-TV service based on a session key including the steps of: selecting a desired pay event using a program guide displayed on a system of the subscriber and achieving a subscriber private key stored as encrypted data in a conditional access module (CAM) by authentication using an identifier; filling out a service application based on service information (SI), signing the service application based on a digital signature scheme and encrypting the digital signed service application; transmitting the encrypted service application to a broadcasting station and waiting a response of the broadcasting station; receiving a session key and a subscription authority message from the broadcasting station, decrypting the session key and the subscription authority message and verifying the digital signature; if an event included in the subscription authority message is started according to success of the digital signature verification, decrypting a channel key encrypted based on the session key, achieving a control word based on the channel key, descrambling event audio/video streams based on the control word and watching the event; and if it is determined that the event is terminated according to the SI or the session key is not effective according to a validity field included in the subscription authority message, stopping watching the event based on the session key and deleting the session key in the CAM.

In accordance with another aspect of the present invention, there is provided a method including the steps of: achieving an encrypted service application from a system of a subscriber; decrypting the encrypted service application and verifying a digital signature of the service application; generating a session key and a subscription authority message according to success of the digital signature verification; signing the subscription authority message based on a digital signature scheme and encrypting the digital signed subscription authority message; transmitting the encrypted subscription authority message to the system of the subscriber; and recording service subscription information on database in order to charge fee of the pay-TV service.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a block diagram showing a conventional pay-TV service;

FIGS. 2A and 2B are flowcharts describing a method for providing a pay-TV service based on a session key in accordance with a preferred embodiment of the present invention; and

FIGS. 3A and 3B are block diagrams illustrating a method for providing a pay-TV service based on a session key in accordance with another embodiment of the present invention.

### DETAILED DESCRIPTION OF THE INVENTION

Herein after, a method for providing a pay-TV service based on a session key will be described in detail with reference to the accompanying drawings.

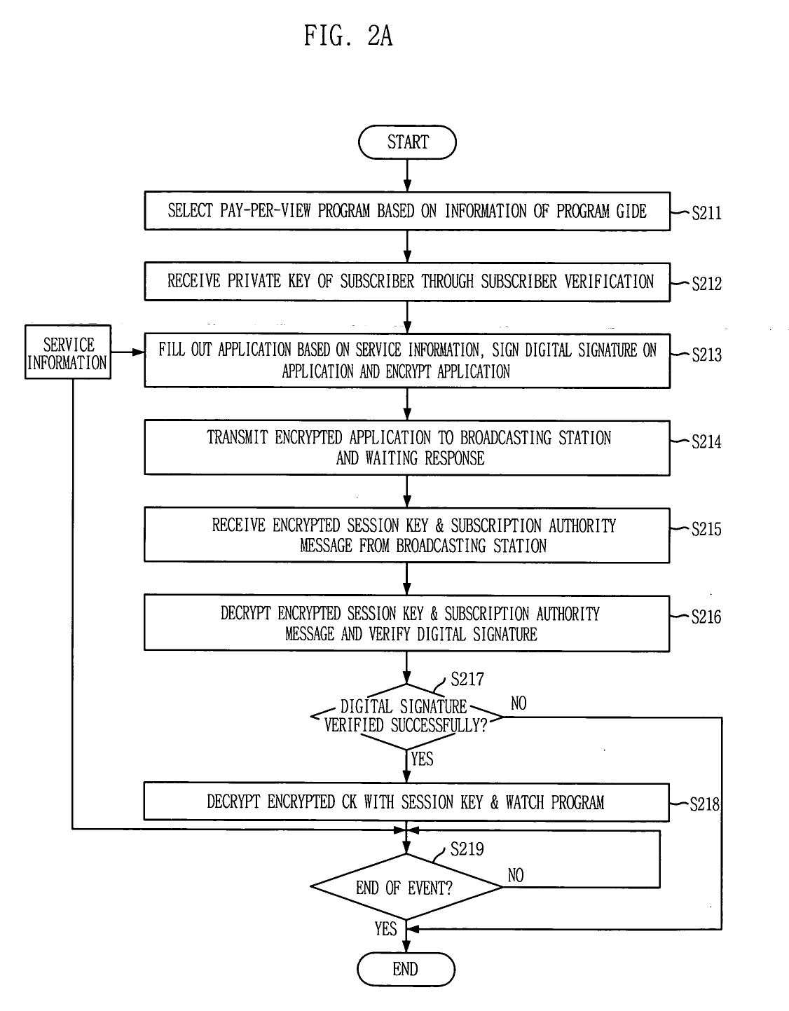

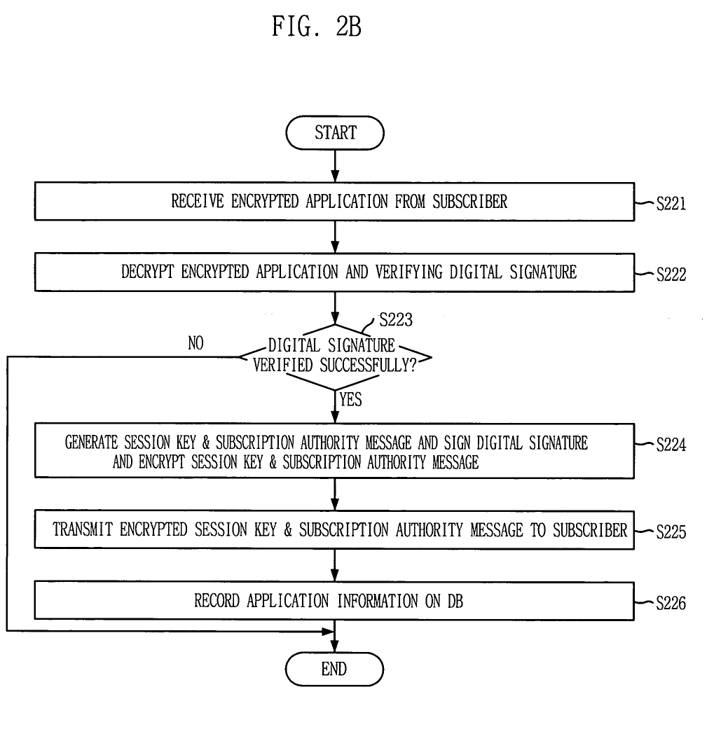

FIGS. 2A and 2B are flowcharts describing a method for providing a pay-TV service based on a session key in accordance with a preferred embodiment of the present invention. FIG. 2A is a flowchart for describing a method for providing a pay-TV service applied to a subscriber and FIG. 2B is a flowchart for describing a method for providing a pay-TV service applied to a broadcasting station.

For authentication of subscribers, a public encryption-based key is used in the present invention. The symmetric encryption-based session key, which is effective during a pay-event broadcasting period, is distributed to the subscribers.

The authentication based on the public encryption-based key can provides a non-repudiation of the subscribers about subscription of a pay-event. By using a different session key to each event, the events can be provided independently. Because the events can be provided independently, a specific event of the pay channel can be provided effectively to the subscribers.

In the present invention, several event subscription methods are described as follows.

First method is to subscribe to the pay-TV service based on a return channel provided by the digital TV system. Second method is to subscribe to the pay-TV service using Internet. Third method is to subscribe to the pay-TV service by calling a staff of the broadcasting station. Because basic steps of the first method and the second method are identical, only for easy description, only the first method is described.

Firstly, the method for subscribing to the pay-TV service D based on the return channel provided by the digital TV system is described.

A user subscribes to the pay-TV service by reading an electronic program guide (EPG) on a TV screen using a remote controller.

When the user subscribes to the pay-TV service using Internet, i.e., the second method operations of the second method are identical to the first method except using the remote controller.

Meanwhile, in the present invention, it is assumed that the broadcasting station and the subscriber generate pairs of a public key and a private key between the broadcasting station and the subscriber, i.e., a broadcasting station-public key (BRO_pub), a broadcasting station-private key (BRO_prv), a subscriber-public key (SUB_pub) and a subscriber-private key (SUB_prv). Also, it is assumed that a broadcasting station certificate (BRO_cert) and a subscriber certificate (SUB_cert) are generated based on a reliable certificate distribution method such as a public key infrastructure (PKI).

Referred to FIGS. 2A and 2B, a process for subscribing to the pay-TV service of the broadcasting station in accordance with the present invention is described as follows.

The subscriber selects a desired event using the EPG on a screen, e.g., a TV screen or a computer monitor at step S211. The subscriber achieves the SUB_prv after authentication of subscriber at step S212.

The subscriber fills out an application using service information. The subscriber signs on the application based on a digital signature scheme and encrypts the application at step S213. The application form is up to a strategy of the broadcasting station but following items [A] have to be included therein. The digital signature and encryption are performed according to following equations [B]. Wherein, the service information (SI) is SI of a digital cable broadcasting system based on OpenCable architecture, a digital satellite broadcasting system based on digital video broadcasting-satellite (DVB-S) architecture or program and system information protocol (PSIP) of advanced television system committee (ATSC).
[A]={Client ID, Date, Service Type, Transport Stream ID, Program Number, Source ID, Event ID, (Series ID)},
wherein the “Client ID” is an identification number of the subscriber, the “Date” is a date of the application submission, the “Service Type” is one of the PPE service, the PPD service, the PPS service, the nVOD service and the VOD service, the “Transport Stream ID” is a transport stream identifier defined in the SI, the “Source ID” is a source identifier defined in the SI, the “Event ID” is an event identifier defined in the SI and the “Series ID” is an identification number of a series. The “Series ID” is effective if the subscriber subscribed to the PPS.
[B] Digital signature=Encrypting the application based on the SUB_prv.
Encryption=Encrypting the digital signed application based on the BRO_pub.

After the step S213, the subscriber transmits the encrypted application to the broadcasting station and waits a response of the broadcasting station at step S214.

Referring to FIG. 2B again, the response of broadcasting station will be described.

The broadcasting station receives the encrypted application at step S221.

The broadcasting station decrypts the encrypted application based on the BRO_prv and verifies the digital signature at step S222.

The verification based on the digital signature includes following steps. The broadcasting station receives the SUB_cert and achieves the SUB_pub. The broadcasting station decrypts the digital signed application. If the broadcasting station successes decryption of the digital signed application, it is regarded that the digital signature verification is successful.

The broadcasting station determines whether the digital signature verification is successful or not at step S223.

If the digital signature verification is successful at the step S223, the broadcasting station generates a session key and a subscription authority message, signs on the session key and the subscription authority message based on a digital signature scheme and encrypts the digital signed session key and the subscription authority message at step S224. The broadcasting station prepares the session key, which is a symmetric-based key, through a key server, etc. before the event is started. A form of the subscription authority message is up to the broadcasting station but following items [C] have to be included therein. The digital signature and encryption method are following equation [D].
[C] subscription authority message={Client ID, Validity, Service Type, Transport Stream ID, Program Number, Source ID, Event ID, (Series ID)},
wherein the “Client ID” is an identification number of the subscriber, the “Validity” is a term of validity of the session key, the “Service Type” is one of the PPE service, the PPD service, the PPS service, the nVOD service and the VOD service, the “Program Number” is a program number defined in the SI, the “Source ID” is a source identification defined in the SI, the “Event ID” is an event identifier defined in the SI and the “Series ID” is an identifier number of a series. The “Series ID” is effective if the subscriber subscribed to the PPS. The event according to the “Source ID” and the “Event ID” is the first event of the series selected by the subscriber.
[D] Digital signature=Encrypting the session key and the subscription authority message based on the BRO_prv.
Encryption=Encrypting the digital signed session key and the digital signed subscription authority message based on the SUB_pub.

The broadcasting station transmits the encrypted session key and the encrypted subscription authority message to the subscriber at step S225.

The broadcasting station records the application information on database for charging fee at step S226. The broadcasting station receives a confirmation message of receiving the session key from the subscriber.

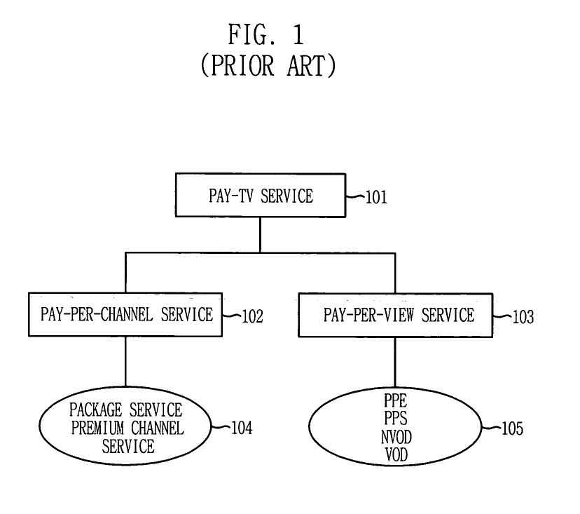

After the step S226, step S215 referred to FIG. 1 is succeeded.

The subscriber receives the encrypted session key and the encrypted subscription authority message from the broadcasting station at step S215.

The subscriber decrypts the encrypted session key and subscription authority message based on the SUB_prv and verifies the digital signature thereof at step S216. For verifying the digital signature, the subscriber decrypts the digital signed session key and subscription authority message. If the subscriber achieves the session key and the subscription authority message after decryption, it is regarded that the digital signature verification is successful.

The subscriber determines whether the digital signature verification is successful or not at step S217. If the verification is failed, the process is terminated. If the verification is successful, the subscriber decrypts a channel key (CK) encrypted based on the session key and achieves a control word (CW) with the CK. The subscriber descrambles the subscribed event audio/video stream and watches the event at step S218.

The subscriber stops using the event and deletes the session key in a CAM memory if the event is terminated according to the SI or if the session key is not effective any more according to the “Validity” field in the subscription authority message. When the subscriber subscribed to the PPS service, the session key (SK) is stored safely till the end of the validity of the selected series. The term of validity of the series can be found according to the “Validity” and the “Series ID” in the subscription authority message. That is, within the “Validity”, if the subscriber subscribes to another event, i.e., a PPS service of which a series ID is identical to the “Series ID” in the subscription authority message, the subscriber uses the SK of the “Series ID”. If the “Validity” is over, the SK is deleted regardless the “Series ID”-exists.

Meanwhile, the second method, which is a method for subscribing to the pay-TV service by calling a staff of the broadcasting station, is as following.

The subscriber selects a desired event using the EPG and calls the staff of the broadcasting station. The subscription authentication and the service subscription are carried out by the staff of the broadcasting station through the call conversation.

The process after the authentication and the subscription is identical to the first method. That is, the process after the step S224 is applied to the first method and the second method equally. The process includes the steps of generating the session key and the subscription authority message, signing based on a digital signature scheme and encrypting the session key and the subscription authority message.

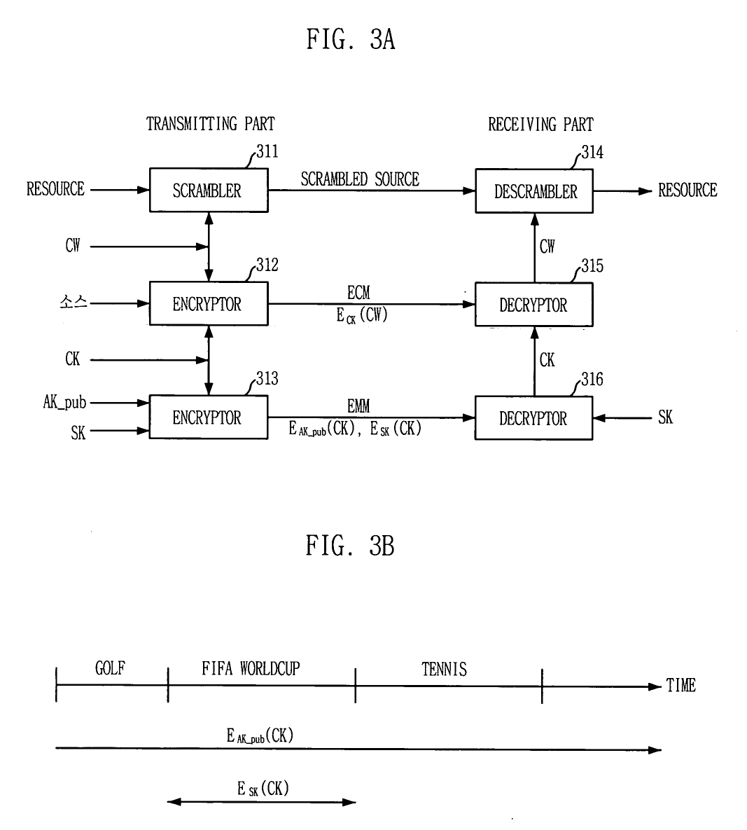

FIGS. 3A and 3B are diagrams showing a method for providing a pay-TV service based on a session key in accordance with another embodiment of the present invention and showing a method for servicing the pay-service per event in the pay channel serving the pay-service per channel.

In the broadcasting station, i.e., a transmitting part of a conditional access system (CAS), the CK is encrypted based on a “AK_pub”, which is a public key of a package group and a “SK”, which is a session key corresponding to a desired event by an encryptor 313, respectively. A transmitting part transmits the CKs encrypted based on the “AK_pub” and the “SK” to a decryptor 315 in a receiving part. Wherein, the receiving part can be a subscriber who does not subscribe to the package service but want to uses a specific event included in the pay channel or who subscribes to the package service.

FIG. 3A is a block diagram for the subscriber who does not subscribe to the package service but wants to watch a specific event included in the pay channel.

A transmitting part includes a scrambler 311 and encryptors 312 and 313. A receiving part includes a descrambler 314 and decryptors 315 and 316.

The scrambler 311 scrambles sources based on the CW and transmits the scrambled sources to the descrambler 314. The encryptor 312 encrypts the CW based on the CK and transmits the encrypted CW to the decryptor 315. The encryptor 313 encrypts the CK based on the AK_pub and the SK and transmits the encrypted CKs to the decryptor 316.

The receiving part using the package service and a premium channel service decrypts the encrypted CK based on the SK by the decryptor 316 and achieves the CK. Wherein, the SK is distributed by the method according to FIGS. 2A and 2B.

The encrypted CW is decrypted based on the achieved CK and CW is achieved. The descrambler 314 descrambles the scrambled source based on the achieved CW and the subscriber watches the desired event.

FIG. 3B is a diagram showing pay events according to time and validity of keys. As shown, events such as golf, FIFA world cup, tennis are serviced. In order to watch the FIFA world cup event, refer to FIG. 3A, the subscriber decrypts the CK encrypted based on the SK of the FIFA world cup, achieves the CK, decrypts the CW based on the achieved CK, descrambles scrambled audio/video stream based on the CW and watches the FIFA world cup.

As shown, the SK is effective when the FIFA world cup is serviced. Therefore, the pay-service per event of the event serviced in the pay channel can be provided based on the session key.

The present invention can effectively provide a pay-service per event. An event is serviced connected to a session. During the session, a session key is used for keeping confidentiality of a pay event. Public-based encryption algorithm is used for safely transmitting the session key to the authenticated subscriber.

The present invention carries out non-repudiation of the subscription to the pay-TV service by using a digital signature scheme based on the public-based encryption algorithm.

The present invention can effectively service pay-service per event of a specific event included in the pay channel servicing the PPC by using a session key.

The present application contains subject matter related to Korean patent application No. 2003-97795, filed in the Korean intellectual Property Office on Dec. 26, 2003, the entire contents of which being incorporated herein by reference.

While the present invention has been described with respect to certain preferred embodiments, it will be apparent to those skilled in the art that various changes and modifications may be made without departing from the scope of the invention as defined in the following claims.

1. A method for providing a pay-TV service based on a session key, the method comprising the steps of:
a) at a subscriber, selecting a desired pay event using a program guide displayed on a system of the subscriber and achieving a subscriber private key stored as encrypted data in a conditional access module (CAM) by authentication using an identifier;
b) at subscriber, filling out a service application based on service information (SI), signing the service application based on a digital signature scheme and encrypting the digital signed service application;
c) at subscriber, transmitting the encrypted service application to a broadcasting station and waiting a response of the broadcasting station;
d) at subscriber, receiving a session key and a subscription authority message from the broadcasting station, decrypting the session key and the subscription authority message and verifying the digital signature;
e) at subscriber, if an event included in the subscription authority message is started according to success of the digital signature verification, decrypting a channel key encrypted based on the session key, achieving a control word based on the channel key, descrambling event audio/video streams based on the control word and watching the event; and
f) at subscriber, if it is determined that the event is terminated according to the SI or the session key is not effective according to a validity field included in the subscription authority message, stopping watching the event based on the session key and deleting the session key in the CAM.

2. The method as recited in claim 1, wherein in the step a), the identifier uses an encryption algorithm based on a password as a standard of public key encryption.

3. The method as recited in claim 1, wherein in the step b), the service application includes an identification number of the subscriber, a date of the service application submission, a service type, a transport stream identifier defined in the SI, a source identifier defined in the SI, an event identifier defined in the SI.

4. The method as recited in claim 3, wherein in the step b), the service application further includes a series identifier.

5. The method as recited in claim 1, wherein in the step b), for the digital signature, the service application is encrypted based on the subscriber private key.

6. The method as recited in claim 1, wherein in the step b), for the encryption, the digital signed service application is encrypted based on a broadcasting station public key.

7. The method as recited in claim 1, wherein in the step d), the subscriber decrypts the encrypted subscription authority message received from the broadcasting station based on the subscriber private key, achieves the session key and the subscription authority message by decrypting the digital signature based on the broadcasting station public key.

8. The method as recited in claim 1, wherein in the step f), if a pay-per-series (PPS) service is subscribed by the subscriber, the session key of a subscribed series is secretly stored in the CAM till the subscribed series is not effective,
wherein the available date of subscribed the series can be found based on a validity and a series identifier included in the subscription authority message, and
wherein if the event, which is a PPS identical to the “Series ID” in the subscription authority message, the corresponding session key is used, and
wherein if the validity is terminated, the session key is deleted no matter the series ID exists.

9. A method for providing a pay-TV service based on a session key of a broadcasting station, the method comprising the steps of:
a) achieving an encrypted service application from a system of a subscriber;
b) decrypting the encrypted service application and verifying a digital signature of the service application;
c) generating a session key and a subscription authority message according to success of the digital signature verification;
d) signing the subscription authority message based on a digital signature scheme and encrypting the digital signed subscription authority message;
e) transmitting the encrypted subscription authority message to the system of the subscriber; and
f) recording service subscription information on database in order to charge fee of the pay-TV service.

10. The method as recited in claim 9, wherein in the step b), the broadcasting station decrypts the service application based on a broadcasting station private key and verifies the digital signature by decrypting the decrypted service application based on a subscriber public key,
wherein if the decryption is successful, the verification of the digital signature is successful, and
wherein the subscriber public key is achieved from a public-key certificate, which is in a directory of the broadcasting station.

11. The method as recited in claim 9, wherein in the step c), the broadcasting system prepares the session key, which is a symmetric-based key from a key server before the event is started.

12. The method as recited in claim 9, wherein in the step c), the subscription authority message includes an identification number of the subscriber, a validity, a service type, a transport stream identifier defined in the SI, a source identifier defined in the SI, an event identifier defined in the SI.

13. The method as recited in claim 12, wherein the step c), the subscription authority message further includes a series identifier.

14. The method as recited in claim 13, wherein the series identifier is effective if the subscriber subscribes to the PPS service, and wherein the event discriminated by the source ID and the event ID is regarded as the first event of the series subscribed by the subscriber.

15. The method as recited in claim 9, wherein in the step d), for the digital signature, the session key and the subscription authority message are encrypted based on the broadcasting station private key.

16. The method as recited in claim 9, wherein the step d), for the encryption, the digital signed session key and subscription authority message are encrypted based on a subscriber public key.

17. The method as recited in claim 9, wherein in the step e), the broadcasting station receives a receive confirmation message from the system of the subscriber in order to check whether the subscriber receives the session key or not.
